(19) United States
(12) Patent Application Publication
(10) Pub. No.: US 2018/0328234 A1
(43) Pub. Date: Nov. 15, 2018

(54) POWER COGENERATION SYSTEM

(71) Applicant: Connected Mobil Group, LLC, Naperville, IL (US)

(72) Inventors: Paul Wolfe, Lexington, SC (US); Prasad Keshava, Naperville, IL (US)

(73) Assignee: Connected Mobil Group, LLC, Naperville, IL (US)

(21) Appl. No.: 15/974,770

(22) Filed: May 9, 2018

Related U.S. Application Data
(60) Provisional application No. 62/504,048, filed on May 10, 2017.

(51) Int. Cl. F01K 23/06; F01D 15/10; F02B 63/04; F01N 3/04; B63H 21/20; F22B 1/18

(52) U.S. Cl. CPC F01K 23/065; F01D 15/10; F02B 63/042; F01N 3/043; B63H 2021/207; F22B 1/1807; F05D 2220/31; F05D 2220/76; B63H 2021/205; B63H 21/20

(57) ABSTRACT

A power cogeneration system employing a steam turbine in association with conventional engines.

### BACKGROUND OF THE INVENTION

### 1) Field of the Invention

The present invention relates to a system for improving power generation from conventional engines.

### 2) Description of Related Art

Current power generation systems, such as, for example, diesel engines, generate power in the forms of kW via an AC generator. This generation accounts for approximately, one-third of the power generation from the engine. However, this system also generates, and losses, almost two thirds of its energy in the form of waste heat.

Take a cruise ship for example, in older iterations “direct drive” diesel engines were used which had the option of using a shaft generator, or generator engine, a device that uses the circular motion of the propeller shaft to generate electricity for hotel services like lighting and cooking. See FIG. 1. Of course, these shaft generators could only be used when the ship is moving at sea with a fairly constant speed; if the propeller shaft was not turning, then neither was the generator, and no electricity was produced. This was remedied by the use of the main engines that are not connected to the propeller shafts; instead, the main engines are directly connected to large generators with one job: producing electricity. The electricity they produce is sent to electric motors, which then power and turn the propellers. See FIG. 2.

The primary advantage of diesel electric systems is efficiency; they allow the main engines to operate near their most efficient speed regardless of whether the ship is moving at 5 knots or 20 knots.

Accordingly, it is an object of the present invention to improve the functioning of current power generation systems and to reduce the waste energy generated by same.

### SUMMARY OF THE INVENTION

The above objectives are accomplished according to the present invention by providing in a first embodiment, a power cogeneration system. The system includes at least one internal combustion engine, a primary generator, at least one steam turbine, a reservoir tank added to the at least one internal combustion engine, a lift pump, a fluid thermally engaged with the at least one internal combustion engine via circulating through an exhaust system jacket, a steam turbine, and a secondary generator driven by the steam turbine through a speed reducer. Further, approximately sixty percent of the lost heat energy is recovered. Still further, the lift pump exerts sufficient pressure to cause the fluid to remain a fluid, even at high temperatures. Further yet, the lift pump raises pressure of the fluid to approximately 200 psia. Yet still, the pressure on the fluid drops to 15 psia after the fluid exits the steam turbine. Again further, an IGBT inverter line syncs power from the secondary generator to add to output of the primary generator. Further still, the fluid is converted to steam and prior to the steam being introduced to the steam turbine, the steam is dried by a steam separator.

In an alternative embodiment, a method of retrofitting a group of internal combustion engines to form a cogeneration system is disclosed. The method includes replacing one of a group of internal combustion engines with a steam turbine, adding a reservoir tank to at least one of the remaining internal combustion engines, wherein the reservoir tank contains a fluid that is thermally engaged with the at least one remaining internal combustion engine via circulating through an exhaust system jacket connected to the at least one internal combustion engine,
passing the fluid through a lift pump to raise pressure of the fluid to ensure the fluid remains a liquid even at high temperatures; introducing the fluid to the steam turbine as a steam; and wherein the steam turbine drives an associated generator through a speed reducer. Further, approximately sixty percent of lost heat energy is recovered. Still further, the lift pump raises pressure of the fluid to approximately 200 psia. Further yet, the pressure on the fluid drops to 15 psia after the fluid exits the steam turbine. Further still, an IGBT inverter line syncs power from the associated generator to add to output of a primary generator. Further yet still, prior to the fluid being introduce to the steam turbine, the fluid is converted to steam and dried by a steam separator.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a prior art direct drive diesel engine configuration.

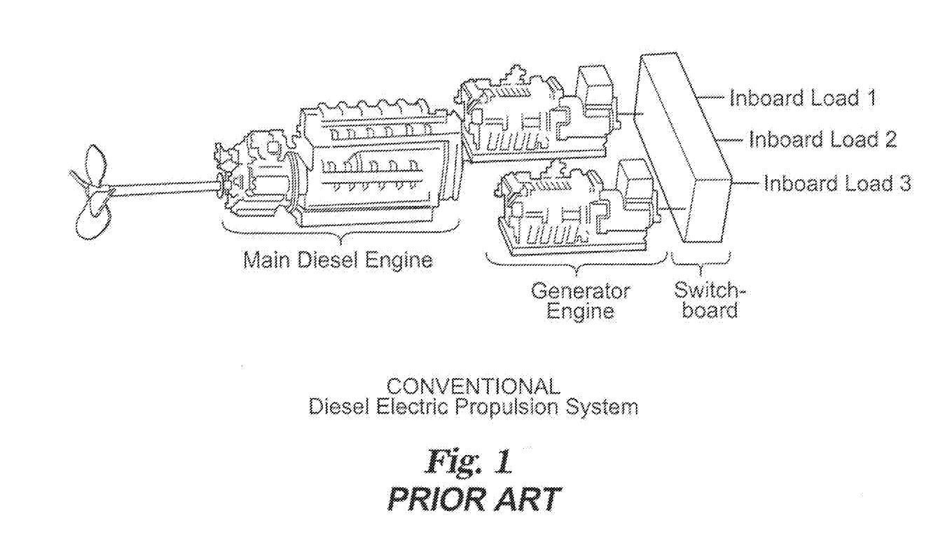

FIG. 2 shows another prior art diesel engine configuration.

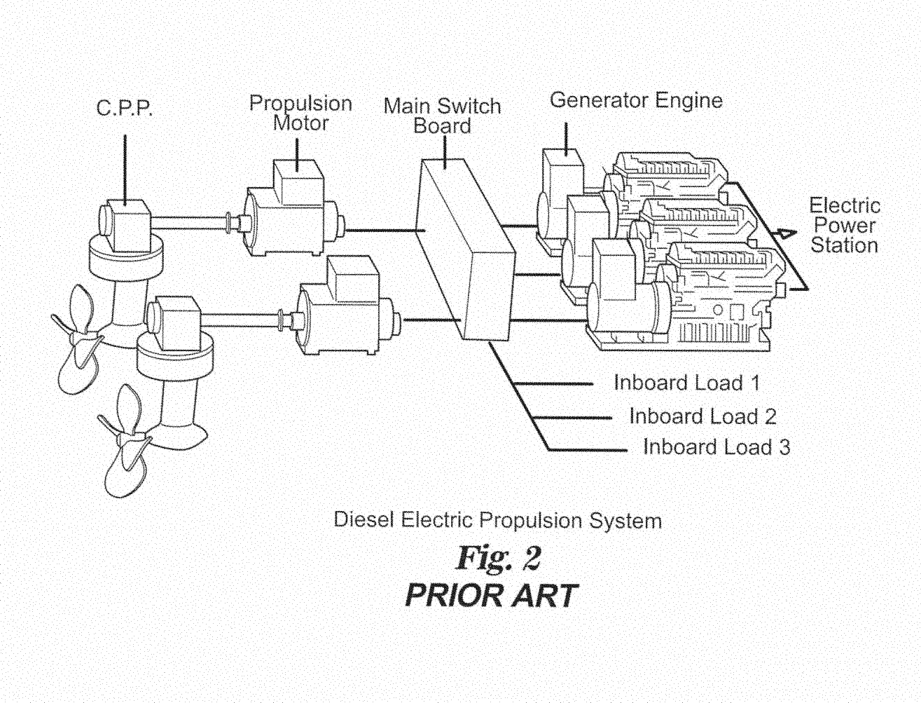

FIG. 3 shows a schematic of a cogeneration system of the current disclosure.

FIG. 4 shows a Cummins 6CT 8.3 liter-G2 diesel engine.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

“Some warships, and a few modern cruise ships have also used steam turbines to improve the efficiency of their gas turbines in a combined cycle, where waste heat from a gas turbine exhaust is utilized to boil water and create steam for driving a steam turbine. In such combined cycles, thermal efficiency can be the same or slightly greater than that of diesel engines alone; however, the grade of fuel needed for these gas turbines is far more costly than that needed for the diesel engines, so the running costs are still higher.” https://en.wikipedia.org/wiki/Marine propulsion

The heat from the exhaust (hot Air) of a gas turbine is used in many cogeneration systems. The hot air looks like the heat (hot air) from a standard water boiler. Gas turbines are a special and expensive power system used where high output and a small, low weight package are required.

The cogeneration system of the present disclosure uses as its heat-source-wasted-heat from an Internal Combustion (IC) engine. IC engines (gasoline or diesel fuel) are very common in use in both stationary power systems and mobile power application. The system covers modification to the IC engine and added hardware required to convert the IC power plant to cogeneration applications. Only a very few Navy and highly special ships can afford gas turbine propulsion systems. All other ships and all large land vehicles use IC engines for propulsion. There are no cogeneration systems available for all of these IC power plants. Special modifications are needed to allow cogeneration on IC engines for example the two stage pumps to collect low temp heat form the engine block and high temperature heat form the engine exhaust (around 1000° C.).

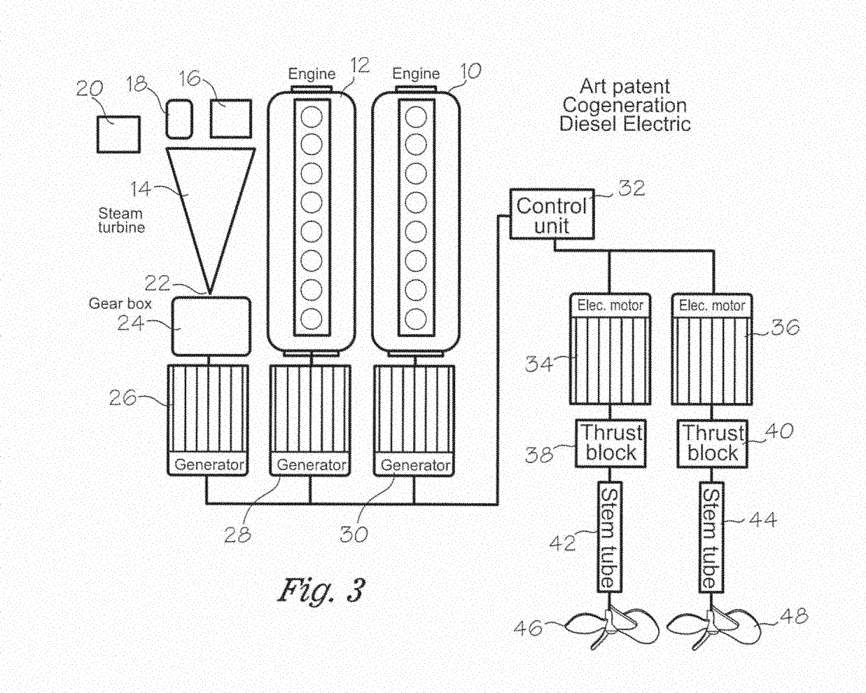

While modern diesel engine configurations produce power at significant levels, improvements are still needed. For example, as shown by FIG. 3, it is possible to replace one of a group of diesel engines with a steam turbine pursuant to the cogeneration system of the current disclosure.

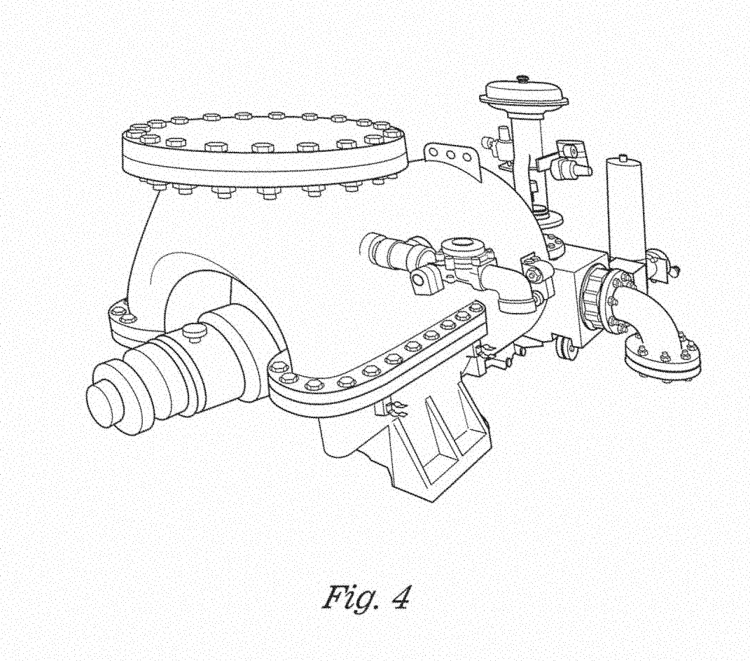

The cogeneration system is designed around, for purposes of example only and not intended to be limiting, a Cummins 6CT 8.3 liter-G2 diesel engine, 3 phase, 125 kW. See FIG. 4. The system will recover some of the 60% (about 200 kW) lost heat energy for the 6CT. The current disclosure may be employed with any IC engine system. The IC engine cooling system in the 6CT runs at 15 PSIA at 100° C. The cooling system of the 6CT will not be changed except to add a reservoir tank, which in one instance may be about 16 liters in volume. (The radiator works as the reservoir tank in a standard system.) The 100° C. coolant that would pass through a lift pump that will raise the pressure from 15 psia to 200 psia. The pressure must be raised to keep the coolant in liquid form at higher temperatures, such as 99° C. target steam/liquid temp. The coolant will flow through a jacket around the exhaust system to remove heat from the turbocharger back. The exhaust temp for the 6CT is 540° C. to 650° C. which is typical for all diesel engines. The superheated coolant will pass through a steam turbine that will drive a generator through a speed reducer, such as a gear box or other means as known to those of skill in the art.

In a further embodiment, the coolant pressure will drop to 15 psia after the turbine and will then return to the standard radiator to be cooled to 100° C. and the cycle will start again. The generator will produce power that will be line synced using a IGBT inverter (standard line sync equipment used in all renewable energy sources) and added to the output of the main generator. The net result will be 125 kw out from the main generator and 70 kW from the steam turbine for a total output of 205 kW using the same amount of fuel as a 125 kW gen set.

FIG. 3 shows first diesel engine 10 and second diesel engine 12 providing power in association with a steam turbine 14. While two diesel engines are shown in FIG. 3, more or less engines are considered encompassed by the current disclosure. Steam turbine 14 works in association with first pump 16 and second pump 18. First pump 16 provides water to the system. The water is the cooling fluid used now in the engine to cool the block and runs through the engine radiator to remove the heat. The steam turbine may remove some of the additional heat. Second pump 18 in turn may be a lift pump to increase the pressure of the water to as high, for example, as 100 psi. The cooling water must be at a high enough pressure to keep it from converting to steam. Water at 14.5 psi will transform to steam at 100° C., at 100 psi the same water will turn to steam at 164° C. The standard engine block and other parts of the engine cannot withstand this high pressure so the current disclosure separates the low temp, low pressure (15 psi at 105° C. for example) part of the cycle from the high temp (100 psi, 164° C. for example) (the steam would need to be above 175° C. (for example) to be used in the turbine without damage) part.

The pressure may be reduced through the steam turbine back to 15 psa (for example) before going through to the engine radiator to cooling back to 100° C. (for example). The temp/pressure for each part of the cycle will be set by the system setup (size of engine, duty cycle, power output, type of IC engine). Before introduction to steam turbine 14, the generated steam will be dried, for instance, by use of a steam separator 20, to remove any moisture from the steam prior to introduction to steam turbine 14. Dry steam has to do with a temperature/pressure curve, when steam is more than 100% dry it is called superheated steam. This type of steam is created by adding heat above the saturated steam threshold. The water/steam at 100 psi (for example) wound need to be above 175° C. to use in the turbine without damage. Once the steam has been dried, it enters steam turbine 14 and turns the blades of same to turn rotor 22 as known to those of skill in the art. Rotor 22 may be connected to a generator through gear box 24 to reduce the rotational speed for the generator (steam turbines work most efficiency at high rotational speed and generators tend to work best at around 3000 rpm (1600 to 3600 rpm) which may be used to generate electrical energy at generator 26, as 1^{st} diesel engine 10 and 2^{nd} diesel engine 12 do with generators 28 and 30, respectively. The electric energy from generators 26, 28, and 30 may then be directed to control unit 32 which can send the electricity throughout the ship as needed. Control unit 32 may also use the electricity to power electric motors 34 and 36, which in turn could work through thrust blocks 38 and 40 to engage proper shafts 42 and 44, which in turn engage and turn propellers 46 and 48. The power from the turbine can be used to power anything for a generator to transform the power to electricity to run light, electric motor, heat, equipment or the power output of the turbine can be used to turn propellers, pumps, fans, winches, anything that need power.

In a further embodiment, when engine is at operating condition (this is an example for one engine, each engine will have a set of temperatures and pressures associated with the operating conditions of the engine (this is provided as a nonlimiting example) cooling fluid normally would run through the engine and then through a radiator for heat transfer to the air to cool the fluid. The operating temperature of the engine is maintained at or around 220° F. and system pressure is maintained at or around 12 to 15 psi.

In the co-gen system of the current disclosure, the cooling fluid would first pass through the engine and then trough a water-to-water heat exchanger that would remove the excess heat and transfer it to the liquid (water ish.). This system would maintain the engine temperature at or around 230° F. the system pressure would be maintained at or around 15 to 20 psi.

The secondary fluid would then go through a pump to raise the pressure to around 400 psi. The fluid then would cool the exhaust system removing heat from the exhaust system and would raise the working fluid to around 500° F.

The fluid would then pass through a steam turbine that would remove much of the energy contained in the steam and the steam generator would convert the energy into mechanical energy that would be used to generate electricity or used the energy to help move the vehicle. Many uses for the extra energy recovered from the waste heat. The system pressure after the steam turbine would be 15 to 20 psi.

The working fluid then would move to a heat exchanger (radiator) to lower the temperature to below 230° F. and the fluid would go around the loop again.

This system would recapture about 10% to 25% efficiency gain over a non co-gen system (standard engine) A 10% to 25% efficiency gain cold be translated in to a fuel savings or more power out of the system.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A power cogeneration system comprising:
at least one internal combustion engine;
a primary generator;
at least one steam turbine;
a reservoir tank added to the at least one internal combustion engine;
a lift pump;
a fluid thermally engaged with the at least one internal combustion engine via circulating
through an exhaust system jacket;
a steam turbine; and
a secondary generator driven by the steam turbine through a speed reducer.

2. The power cogeneration system of clam 1, wherein approximately sixty percent of lost heat energy is recovered.

3. The power cogeneration system of claim 1, wherein the lift pump exerts sufficient pressure to cause the fluid to remain a fluid, even at high temperatures.

4. The power cogeneration system of claim 1, wherein the lift pump raises pressure of the fluid to approximately 200 psia.

5. The power cogeneration system of claim 1, wherein the pressure on the fluid drops to 15 psia after the fluid exits the steam turbine.

6. The power cogeneration system of claim 1, further comprising an IGBT inverter that line syncs power from the secondary generator to add to output of the primary generator.

7. The power cogeneration system of claim 1, wherein the fluid is converted to steam and prior to the steam being introduced to the steam turbine, the steam is dried by a steam separator.

8. A method of retrofitting a group of internal combustion engines to form a cogeneration system comprising:
replacing one of a group of internal combustion engines with a steam turbine;
adding a reservoir tank to at least one of the remaining internal combustion engines, wherein the reservoir tank contains a fluid that is thermally engaged with the at least one remaining internal combustion engine via circulating through an exhaust system jacket connected to the at least one internal combustion engine;
passing the fluid through a lift pump to raise pressure of the fluid to ensure the fluid remains a liquid even at high temperatures;
introducing the fluid to the steam turbine as a steam; and
wherein the steam turbine drives an associated generator through a speed reducer.

9. The method of claim 8, wherein approximately sixty percent of lost heat energy is recovered.

10. The method of claim 8, wherein the lift pump raises pressure of the fluid to approximately 200 psia.

11. The method of claim 8, wherein the pressure on the fluid drops to 15 psia after the fluid exits the steam turbine.

12. The method of claim 8, wherein comprising an IGBT inverter that line syncs power from the associated generator to add to output of a primary generator.

13. The method of claim 8, wherein prior to the fluid being introduce to the steam turbine, the fluid is converted to steam and dried by a steam separator.
